(19) United States
(12) Patent Application Publication
(10) Pub. No.: US 2017/0022929 A1
(43) Pub. Date: Jan. 26, 2017

(54) WATER JACKET SPACER

(71) Applicants: Takashi KARITA, Toyota-shi (JP); Kazunari TAKENAKA, Toyota-shi (JP); Shinsuke SUGIMOTO, Toyota-shi (JP); Akihiro YOSHIMURA, Tokyo (JP); Kazuaki NISHIO, Tokyo (JP)

(72) Inventors: Takashi KARITA, Toyota-shi (JP); Kazunari TAKENAKA, Toyota-shi (JP); Shinsuke SUGIMOTO, Toyota-shi (JP); Akihiro YOSHIMURA, Tokyo (JP); Kazuaki NISHIO, Tokyo (JP)

(73) Assignees: TOYOTA JIDOSHA KABUSHIKI KAISHA, Toyota-shi (JP); NICHIAS CORPORATION, Tokyo (JP)

(21) Appl. No.: 15/117,867

(22) PCT Filed: Mar. 18, 2015
(86) PCT No.: PCT/JP2015/058142

§ 371 Date: Aug. 10, 2016

(30) Foreign Application Priority Data
Mar. 31, 2014 (JP) 2014-073427
Jan. 6, 2015 (JP) 2015-001087

(51) Int. Cl. F02F 1/16; F01P 3/02; F02F 1/36

(52) U.S. Cl. CPC F02F 1/166; F02F 1/36; F01P 3/02; F01P 2003/021

(57) ABSTRACT

A water jacket spacer is inserted into a water jacket. The water jacket spacer includes an expansion member, a plate-shaped holder to which the expansion member is fixed, and a leaf spring that abuts the inner wall of the water jacket. The leaf spring projects from a face on the holder on the side opposite of the expansion member. The holder curves to match the shape of the water jacket. The position of the water jacket spacer in the water jacket is maintained by the biasing force of the leaf spring.

### TECHNICAL FIELD

The present invention relates to a water jacket spacer.

### BACKGROUND ART

Water jacket spacers have been proposed that optimize the flow of water in a water jacket and improve temperature distribution on a cylinder wall. Such a water jacket spacer is inserted in the water jacket of a cylinder block to be used.

Patent Document 1 discloses a water jacket spacer that includes an expansion member formed of water-swelling cellular rubber, which expands when it comes into contact with a coolant. The water jacket spacer disclosed in Patent Document 1 is inserted in the water jacket through a hole in the upper surface of the cylinder block. When the water jacket spacer is inserted in the water jacket, the expansion member expands in the water jacket. Thus, the water jacket spacer is secured in the water jacket. In this case, the water jacket spacer needs to be held in a predetermined position until the water jacket spacer is secured by the expansion of the expansion member. For this reason, the lower section of the water jacket spacer is configured to sandwich a projection on the bottom surface of the water jacket.

However, when the water jacket spacer is applied to the water jacket of the cylinder block having an open-deck structure, the position of the water jacket spacer in the water jacket cannot be determined easily.

### PRIOR ART DOCUMENT

### Patent Document

Patent Document 1: Japanese Laid-Open Patent Publication No. 2004-19475

### SUMMARY OF THE INVENTION

### Problems that the Invention is to Solve

Accordingly, it is an objective of the present invention to provide a water jacket spacer that has a simple structure and is capable of being secured before an expansion member is expanded in a state in which the water jacket spacer is inserted in a water jacket.

### Means for Solving the Problems

To solve the above problems and in accordance with a first aspect of the invention of the present application, a water jacket spacer is provided that is applied to a cylinder block, which includes a water jacket that surrounds cylinder bores, and is inserted in the water jacket. The water jacket spacer includes an expansion member, a plate-shaped holder, and an elastic member. The expansion member is arranged corresponding to each cylinder bore and expands in the water jacket. The expansion member is secured to the plate-shaped holder. The elastic member projects from the other side of the holder from the side on which the expansion member is provided and abuts against an inner wall of the water jacket. The holder curves to be shaped in conformance with the water jacket. The elastic member exerts an urging force to maintain the position of the holder in the water jacket.

With the above configuration, when the water jacket spacer is inserted in the water jacket, the elastic member is deformed. The elastic member is located on the back side from the expansion member. Thus, the urging force generated by the deformation of the elastic member presses the water jacket spacer against the inner wall of the water jacket. Thus, the position of the water jacket spacer in the water jacket is maintained by the urging force of the elastic member. Furthermore, the above configuration eliminates the need for a protrusion for supporting the water jacket spacer. That is, the water jacket spacer is secured between the walls of the water jacket with a simple structure in which only the elastic member is provided on the water jacket spacer. That is, a water jacket spacer is provided that has a simple structure and is capable of being secured before the expansion member is expanded in a state in which the water jacket spacer is inserted in the water jacket.

In the water jacket spacer described above, the cylinder block is preferably an open-deck cylinder block, the expansion member is preferably one of expansion members, and the expansion members are preferably secured to the holder.

With the above configuration, the expansion members are coupled by the holder. Furthermore, the holder curves to be shaped in conformance with the water jacket. Thus, the water jacket spacer inserted in the water jacket is hard to move in the circumferential direction of the water jacket. This allows the position of the expansion members to be easily determined by only inserting the water jacket spacer in the water jacket.

In the water jacket spacer described above, the water jacket is preferably divided into two regions in the circumferential direction by an imaginary straight line that passes through all central axes of the cylinder bores, and the holder preferably couples all the expansion members arranged in one of the two regions of the water jacket.

With the above configuration, the expansion members are simultaneously inserted in half the region of the water jacket.

In the water jacket spacer described above, the water jacket spacer is preferably one of a pair of water jacket spacers, and the pair of water jacket spacers is preferably inserted in the water jacket.

With the above configuration, when the water jacket spacers are each inserted in the water jacket, the area of a section that produce friction with the wall of the water jacket is less than that in a case in which a single water jacket spacer that surrounds all the cylinder bores is inserted. As a result, the insertion load when each of the water jacket spacers is inserted is less than the insertion load when a single water jacket spacer that surrounds all the cylinder bores is inserted. This reduces the insertion load of the water jacket spacer that acts on the thrust side of the cylinder block and the insertion load of the water jacket spacer that acts on the non-thrust side of the cylinder block.

In the water jacket spacer described above, the elastic member preferably projects at an angle from the holder, the elastic member preferably extends from an edge section of the water jacket spacer from which the water jacket spacer is inserted to gradually separate from the expansion member in a direction away from the edge section, and the elastic member is preferably a leaf spring that abuts against the inner wall of the water jacket.

With the above configuration, the leaf spring projects at an angle from the edge section of the water jacket spacer from which the water jacket spacer is inserted. Thus, when the water jacket spacer is inserted in the water jacket, the leaf spring abuts against the inner wall of the water jacket. In this case, when the insertion depth of the water jacket spacer is small, the deformation amount of the leaf spring is small, and the urging force generated by the deformation of the leaf spring is also small. When the insertion depth of the water jacket spacer is increased, the urging force of the leaf spring is increased, and the insertion load of the water jacket spacer is also increased. This reduces the insertion load when the insertion depth of the water jacket spacer is small. Thus, the work amount in inserting the water jacket spacer is reduced.

In the water jacket spacer described above, the leaf spring preferably includes an abutment portion that abuts against the inner wall of the water jacket, the abutment portion is preferably formed by having part of the leaf spring to be curved, and the abutment portion is preferably located at a position further than a center in an insertion direction of the water jacket spacer in a direction opposite to the insertion direction.

With the above configuration, when the abutment portion of the leaf spring abuts against the inner wall of the water jacket, the leaf spring is flexed to the most, and the load caused by the urging force of the leaf spring is maximized. Furthermore, the abutment portion of the leaf spring abuts against the inner wall of the water jacket at a position further than the center of the water jacket spacer in a direction opposite to the insertion direction. Thus, the load caused by the urging force of the leaf spring is maximized when the water jacket spacer is inserted in the water jacket by half or more than half the length of the water jacket spacer. This further reduces the insertion load when the insertion depth of the water jacket spacer is small.

### BRIEF DESCRIPTION OF THE DRAWINGS

FIG. 1 is a perspective view of a water jacket spacer according to a first embodiment of the present invention;

FIG. 2 is a plan view of a cylinder block to which the water jacket spacer is applied as viewed from the openings of the cylinder bores;

FIG. 3 is a plan view of the cylinder block with the water jacket spacers inserted in the water jacket;

FIG. 4 is a cross-sectional view taken along line 4-4 of FIG. 3;

FIGS. 5(a) to 5(c) are schematic diagrams illustrating operation of a leaf spring when the water jacket spacer is inserted in the water jacket;

FIG. 6 is a partial cross-sectional view of the cylinder block with a water jacket spacer according to a second embodiment of the present invention inserted in the water jacket;

FIGS. 7(a) to 7(c) are schematic diagrams illustrating operation of the leaf spring when the water jacket spacer according to the second embodiment is inserted in the water jacket; and

FIG. 8 is a graph showing the relationship between insertion depth and insertion load when the water jacket spacer is inserted in the water jacket.

### MODES FOR CARRYING OUT THE INVENTION

### First Embodiment

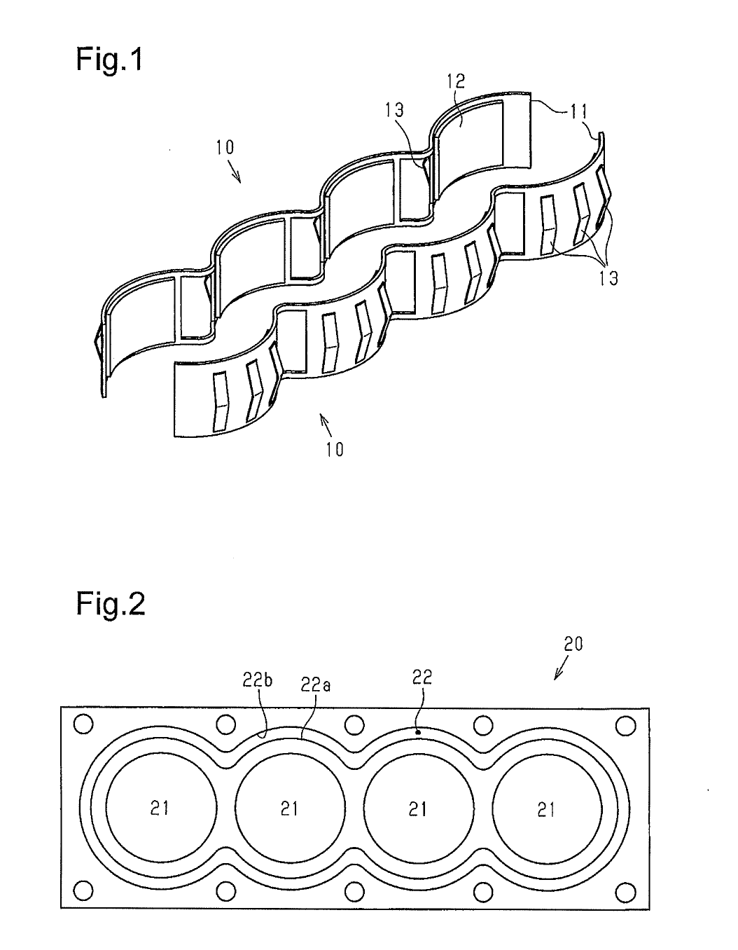

A water jacket spacer according to a first embodiment of the present invention will now be described with reference to FIGS. 1 to 5(c).

As shown in FIG. 1, water jacket spacers 10 are used in a pair. Each water jacket spacer 10 includes a metal plate-shaped holder 11 and expansion members 12, which are secured to the holder 11. The water jacket spacer 10 is configured by coupling four expansion members 12 with one another using the holder 11. The expansion members 12 are thermal expansion members, which expand upon receipt of heat. Each holder 11 includes leaf springs 13 on the other side of the holder 11 from the side on which the expansion members 12 are provided. Three leaf springs 13 are provided at a position corresponding to each expansion member 12.

FIG. 2 shows a cylinder block 20, which includes a water jacket 22 to which the water jacket spacers 10 are applied. The cylinder block 20 is for an in-line four-cylinder internal combustion engine and includes four cylinder bores 21. The water jacket 22 for circulating a coolant is formed around the cylinder bores 21. The cylinder block 20 has an open-deck structure. The water jacket spacers 10 are inserted in the opening of the water jacket 22 to be used. The wall of the water jacket 22 that is in the vicinity of the cylinder bores 21 is referred to as a first wall 22a, and the wall opposite to the first wall 22a is referred to as a second wall 22b.

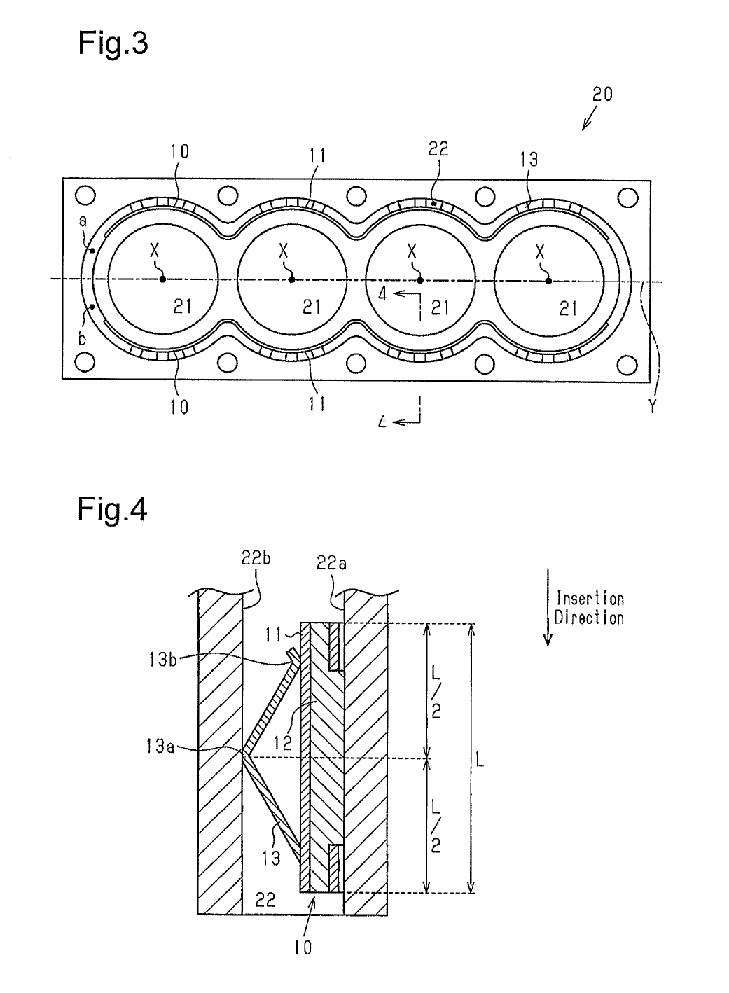

As shown in FIG. 3, each holder 11 curves in a waveform to be shaped in conformance with the shape of the water jacket 22 of the cylinder block 20. Two water jacket spacers are inserted in the water jacket 22 as shown in FIG. 1.

The entire length of the holder 11, or the water jacket spacer 10, in the longitudinal direction is less than half the entire length of the water jacket 22 in the circumferential direction. That is, the sum of the entire lengths of the two water jacket spacers 10 is less than the entire length of the water jacket 22. This structure provides spaces between the two water jacket spacers 10 in a state in which the two water jacket spacers 10 are inserted in the water jacket 22. Thus, the expansion members 12 are not inserted in the left and right ends of the water jacket 22 shown in FIG. 3. In a state in which the two water jacket spacers 10 are inserted in the water jacket 22, two expansion members 12 are arranged to face each of the four cylinder bores 21.

The expansion members 12 are arranged in the left and right direction shown in FIG. 3, that is, in the longitudinal direction of the cylinder block 20. In other words, the water jacket spacer 10 is configured by coupling the four expansion members 12 arranged in the longitudinal direction with one another using the holder 11. An imaginary straight line Y shown in FIG. 3 is a straight line that passes through all the central axes X of the four cylinder bores 21. The four expansion members 12, which are coupled with one another using the holder 11, are arranged in one of two regions a, b of the water jacket 22 divided by the imaginary straight line Y in the circumferential direction.

FIG. 4 shows the water jacket spacer 10 inserted in the water jacket 22. Arrow in FIG. 4 shows the direction in which the water jacket spacer 10 is inserted in the water jacket 22. As shown in FIG. 4, when the water jacket spacer 10 is inserted in the water jacket 22, the holder 11 abuts against the first wall 22a of the water jacket 22, and the leaf spring 13 abuts against the second wall 22b. FIG. 4 shows a state in which the expansion member 12 is expanded after the water jacket spacer 10 is inserted in the water jacket 22. Thus, the expansion member 12 abuts against the first wall 22a.

The leaf spring 13 includes a proximal end at the edge section of the water jacket spacer 10 from which the water jacket spacer 10 is inserted into the water jacket 22. The leaf spring 13 also includes an abutment portion 13a, which abuts against the second wall 22b, and a distal end portion 13b, which abuts against the holder 11. Since the leaf spring 13 is bent at the abutment portion 13a, the leaf spring 13 extends to gradually separate from the holder 11 and the expansion member 12 from the proximal end toward the abutment portion 13a and to approach the holder 11 and the expansion member 12 from the abutment portion 13a toward the distal end portion 13b. When the length of the water jacket spacer 10 in the insertion direction is defined by L, the abutment portion 13a is located at a position L/2 from the proximal end of the leaf spring 13, that is, at the center of the water jacket spacer 10 in the insertion direction.

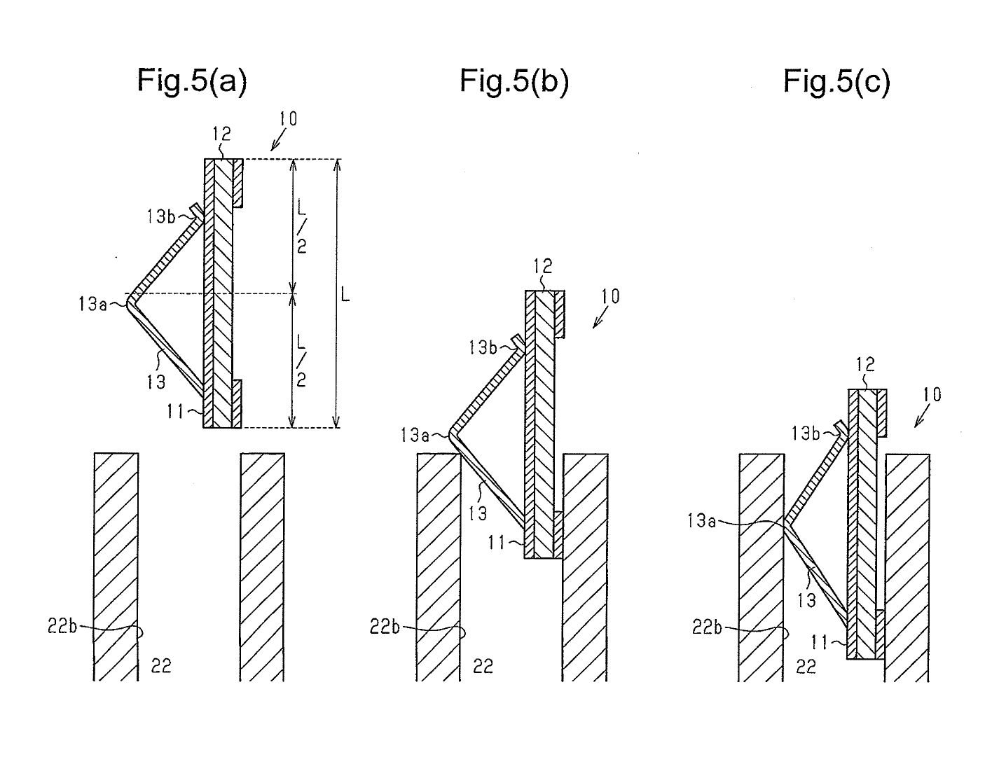

Operation of the leaf spring 13 when the water jacket spacer 10 is inserted into the water jacket 22 will now be described with reference to FIGS. 5(a) to 5(c).

FIG. 5(a) shows a state before the water jacket spacer 10 is inserted in the water jacket 22. FIG. 5(b) shows a state in which insertion of the water jacket spacer 10 is started, and a section between the proximal end of the leaf spring 13 and the abutment portion 13a is in contact with the opening edge of the second wall 22b. FIG. 5(c) shows a state in which the water jacket spacer 10 is further inserted, and the abutment portion 13a is in contact with the second wall 22b. In either state, the expansion member 12 is not expanded, and the holder 11 abuts against the first wall 22a.

As shown in FIG. 5(a), the leaf spring 13 is not deformed before the water jacket spacer 10 is inserted. In this state, the abutment portion 13a of the leaf spring 13 is located closer to the insertion edge than the center of the water jacket spacer 10. When the water jacket spacer 10 is inserted in the water jacket 22, the leaf spring 13 abuts against the second wall 22b of the water jacket 22 and is deformed as shown in FIG. 5(b). As described above, the leaf spring 13 projects at an angle from the holder 11 to gradually separate from the expansion member 12 from the proximal end toward the abutment portion 13a. Thus, as the insertion depth of the water jacket spacer 10 is increased, the deformation amount of the leaf spring 13 is increased.

Consequently, as shown in FIG. 5(b), when the insertion depth of the water jacket spacer 10 is small, the deformation amount of the leaf spring 13 is small, and urging force generated by the deformation of the leaf spring 13 is also small. As shown in FIG. 5(c), as the insertion depth of the water jacket spacer 10 is increased, the deformation amount of the leaf spring 13 is maximized, and the urging force of the leaf spring 13 is also maximized. That is, although the insertion load is increased in accordance with the insertion depth of the water jacket spacer 10, the insertion load is kept small when the insertion depth is small.

Operation of the above-described water jacket spacer 10 will now be described with reference to FIGS. 3 and 4.

As shown in FIG. 3, the holder 11 curves to be shaped in conformance with the water jacket 22. Furthermore, the four expansion members 12 are coupled to one another using the holder 11. Thus, the water jacket spacer 10 inserted in the water jacket 22 is hard to move in the circumferential direction of the water jacket 22.

As shown in FIG. 4, the water jacket spacer 10 inserted in the water jacket 22 is urged by the leaf spring 13 toward the first wall 22a to be pressed against the first wall 22a. In this manner, the water jacket spacer 10 is secured in the water jacket 22 by the urging force of the leaf springs 13.

When the internal combustion engine is warmed up with the water jacket spacers 10 inserted in the water jacket 22, heat generated by the internal combustion engine expands the expansion members 12. That is, the expansion members 12 expand to fill the water jacket 22. Thus, at sections in which the water jacket spacers 10 are inserted, the expansion members 12 reduce the volume of the passage of the water jacket 22 and optimize the flow of the coolant that circulates in the water jacket 22. The volume of the expansion members 12 that have been expanded is maintained within the water jacket 22.

The first embodiment provides the following advantages.

(1) When the water jacket spacer 10 is inserted in the water jacket 22, the leaf springs 13 are deformed. Furthermore, the leaf springs 13 are arranged on the back side from the expansion members 12. Thus, by the urging force generated by the deformation of the leaf springs 13, the water jacket spacer 10 is pressed against the inner wall of the water jacket 22. That is, before the expansion members 12 expand, the abutment portions 13a of the leaf springs 13 abut against the first wall 22a of the water jacket 22, and the holder 11 abuts against the second wall 22b of the water jacket 22. The position of the water jacket spacer 10 in the water jacket 22 is maintained in this state by the urging force of the leaf springs 13. This eliminates the need for a protrusion for supporting the water jacket spacer 10. That is, the water jacket spacer 10 is secured between the walls of the water jacket 22 with a simple structure in which only the leaf springs 13 are provided on the water jacket spacer 10. That is, the water jacket spacer 10 is provided that has a simple structure and is capable of being secured before the expansion members 12 are expanded in a state in which the water jacket spacer 10 is inserted in the water jacket 22.

(2) The leaf springs 13 project at an angle from the edge section of the water jacket spacer 10 from which the water jacket spacer 10 is inserted. When the water jacket spacer 10 is inserted into the water jacket 22, the leaf springs 13 abut against the second wall 22b of the water jacket 22. Thus, when the insertion depth of the water jacket spacer 10 is small, the deformation amount of the leaf springs 13 is small, and the urging force generated by the deformation of the leaf springs 13 is also small. As the insertion depth of the water jacket spacer 10 is increased, the urging force of the leaf springs 13 is increased, and the insertion load of the water jacket spacer 10 is increased. That is, the work load at the time of insertion is reduced since the insertion load is small when the insertion depth of the water jacket spacer 10 is small.

(3) The expansion members 12 are coupled with one another using the holder 11. Furthermore, the holder 11 curves to be shaped in conformance with the water jacket 22. Thus, the water jacket spacer 10 inserted in the water jacket 22 is hard to move in the circumferential direction of the water jacket 22. Consequently, the position of the expansion members 12 are easily determined only by inserting the water jacket 22 in the water jacket spacer 10.

(4) The holder 11 curves to be shaped in conformance with the water jacket 22. Thus, when the water jacket spacer 10 is inserted in the water jacket 22, the holder 11 does not need to be deformed in accordance with the shape of the water jacket 22. Consequently, the performance in inserting the water jacket spacer 10 is improved.

(5) The four expansion members 12 are arranged in the longitudinal direction of the cylinder block 20 and are integrated by the holder 11. Thus, the four expansion members 12 are simultaneously inserted in half the region of the water jacket 22. That is, the performance in inserting the water jacket spacer 10 is improved.

(6) When the two water jacket spacers 10 are inserted in the water jacket 22, the area of the section that produce friction on the wall of the water jacket 22 is less than that when a water jacket spacer that surrounds all the cylinder bores 21 is inserted. As a result, the insertion load that is required when the two water jacket spacers 10 are inserted is less than the insertion load when the water jacket spacer that surrounds all the cylinder bores 21 is inserted. Consequently, the insertion load of the water jacket spacer 10 is reduced.

(7) In the water jacket 22, the water jacket spacers 10 are not arranged at both ends of the cylinder block 20 in the longitudinal direction, and spaces are formed. The object of arranging the water jacket spacer in the water jacket is to prevent the wall of the cylinder bores from being excessively cooled by arranging the expansion members on both the thrust side and the non-thrust side, where the pistons sliding in the cylinders, which are formed by the cylinder bores, contact the walls of the cylinder bores to optimize the flow of the coolant. That is, no expansion member needs to be arranged at a position where the wall of the cylinder bore is less likely to contact the piston compared with both the thrust side and the non-thrust side. The above configuration provides the water jacket spacer using the minimum amount of expansion members by forming spaces in both ends of the water jacket 22. Consequently, since the entire length of the water jacket spacer 10 is reduced, the insertion load of the water jacket spacer 10 is reduced.

### Second Embodiment

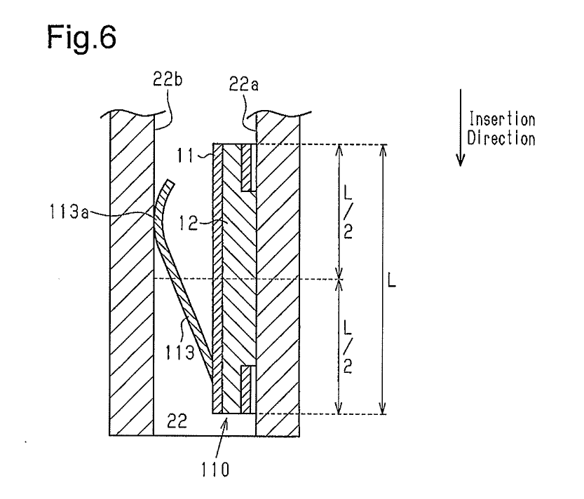

A water jacket spacer according to a second embodiment of the present invention will now be described with reference to FIGS. 6 to 8.

In a water jacket spacer 110 of the second embodiment, the shape of a leaf spring 113 differs from that of the leaf spring 13 of the first embodiment. The same reference numerals are given to those components that are common to the first embodiment, and detailed explanations are omitted.

FIG. 6 shows a state in which the expansion member 12 is expanded after the water jacket spacer 110 is inserted in the water jacket 22. Arrow in FIG. 6 shows the insertion direction of the water jacket spacer 110.

As shown in FIG. 6, the leaf spring 113 includes a proximal end at the edge section of the water jacket spacer 110 from which the water jacket spacer 110 is inserted into the water jacket 22. The leaf spring 113 also includes an abutment portion 113a, which abuts against the second wall 22b. The leaf spring 113 extends from the proximal end to the abutment portion 113a so as to gradually separate from the holder 11 and the expansion member 12 and curves at the abutment portion 113a.

When the water jacket spacer 110 is inserted in the water jacket 22, the expansion members 12 expand and abut against the first wall 22a of the water jacket 22, and the leaf springs 113 abut against the second wall 22b. When the length of the water jacket spacer 110 in the insertion direction is defined by L, the abutment portion 113a is located at a position further than L/2 from the proximal end of the leaf spring 13, that is, a position further than the center of the water jacket spacer 110 in a direction opposite to the insertion direction.

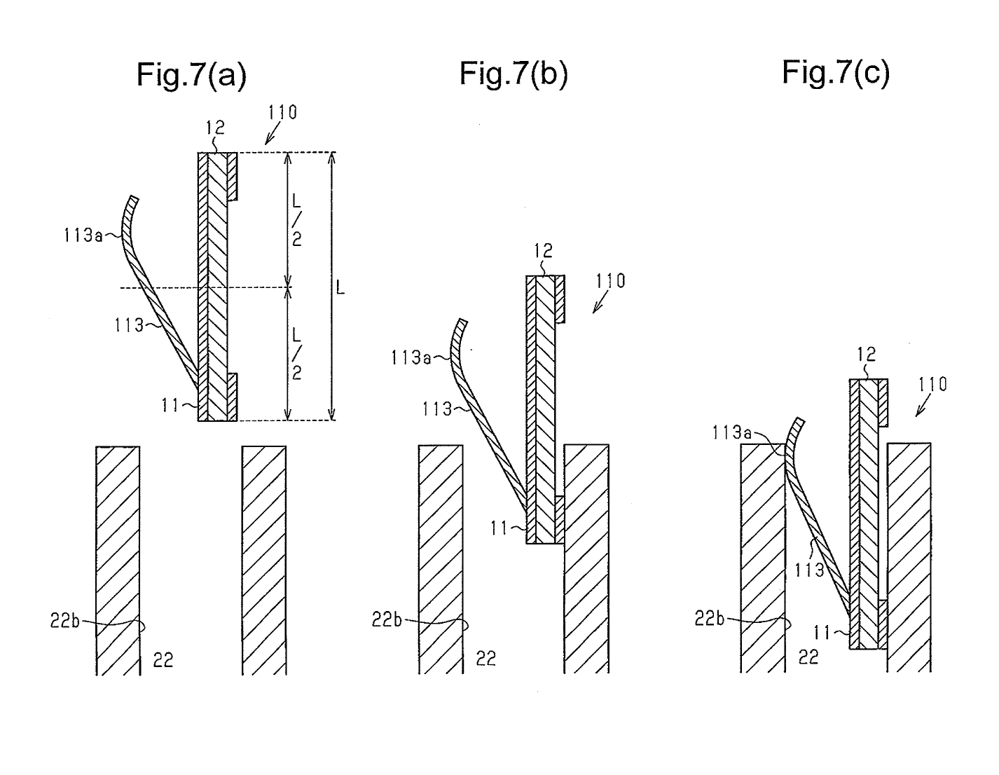

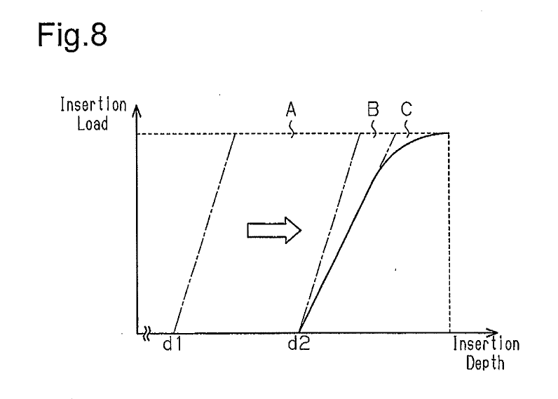

Operation of the above-described water jacket spacer 110 will now be described with reference to FIGS. 7(a) to 8. First, the operation of the leaf spring 113 when the water jacket spacer 110 is inserted into the water jacket 22 will be described with reference to FIGS. 7(a) to 7(c).

FIG. 7(a) shows a state before the water jacket spacer 110 is inserted in the water jacket 22. FIG. 7(b) shows a state in which insertion of the water jacket spacer 110 is started. FIG. 7(c) shows a state in which the water jacket spacer 110 is further inserted, and the abutment portion 113a is in contact with the second wall 22b. In either state, the expansion member 12 is not expanded, and the holder 11 abuts against the first wall 22a.

As shown in FIG. 7(a), the leaf spring 113 is not deformed before the water jacket spacer 110 is inserted. In this state, the abutment portion 113a of the leaf spring 113 is located further than the center of the water jacket spacer 110 in a direction opposite to the insertion direction. When the water jacket spacer 110 is inserted in the water jacket 22, the leaf spring 113 abuts against the second wall 22b of the water jacket 22. The leaf spring 113 projects at an angle from the holder 11. The leaf spring 113 extends from the proximal end in a direction opposite to the insertion direction of the water jacket spacer 110 so as to gradually separate from the expansion member 12. Thus, when the insertion depth of the water jacket spacer 110 is increased, the deformation amount of the leaf spring 113 is increased. Consequently, when the insertion depth of the water jacket spacer 110 is small, the deformation amount of the leaf spring 113 is small, and the urging force generated by the deformation of the leaf spring 113 is also small.

As described above, the abutment portion 113a is located at a position further than the center of the water jacket spacer 110 in a direction opposite to the insertion direction. Thus, as shown in FIG. 7(b), although the water jacket spacer 110 according to the second embodiment is inserted to the depth at which the leaf spring 13 of the water jacket spacer 10 according to the first embodiment starts to abut against the second wall 22b, the leaf spring 113 does not abut against the second wall 22b. That is, unless the water jacket spacer 110 is inserted deeper than the position shown in FIG. 7(b), the leaf spring 113 does not abut against the second wall 22b. In other words, when the insertion depth of the water jacket spacer 110 is small, the leaf spring 113 does not abut against the second wall 22b, and the leaf spring 113 does not deform. Thus, the urging force does not occur in the leaf spring 113 since the leaf spring 113 is not deformed.

As shown in FIG. 7(c), when the water jacket spacer 110 is inserted deeper, the leaf spring 113 abuts against the second wall 22b. When the insertion depth of the water jacket spacer 110 is increased, the deformation amount of the leaf spring 113 is increased, and the urging force that is generated in the leaf spring 113 is also increased. Thus, the insertion load of the water jacket spacer 110 is increased. When the abutment portion 113a of the leaf spring 113 abuts against the second wall 22b, the deformation amount of the leaf spring 113 is maximized, and the urging force of the leaf spring 113 is also maximized. Thus, the insertion load of the water jacket spacer 110 is increased.

Furthermore, the abutment portion 113a of the leaf spring 113 is curved. Thus, the deformation amount gradually changes until the deformation amount of the leaf spring 113 is maximized. Thus, the urging force generated by the deformation of the leaf spring 113 is also gradually changed. Consequently, the insertion load of the water jacket spacer 110 is also gradually increased. This further reduces the insertion load when the insertion depth of the water jacket spacer 110 is small. Furthermore, load is also gradually increased until the insertion load of the water jacket spacer 110 is maximized.

Subsequently, increasing tendency of the insertion load of the water jacket spacer 110 will be described with reference to FIG. 8. The water jacket spacer 110 of the second embodiment and the water jacket spacer 10 of the first embodiment are compared with each other for description. Solid line in FIG. 8 shows the relationship between the insertion depth and the insertion load when the water jacket spacer 110 is inserted in the water jacket 22. The dashed line in FIG. 8 shows the relationship between the insertion depth and the insertion load when the water jacket spacer 10 of the comparative example is inserted in the water jacket 22.

The abutment portion 13a of the water jacket spacer 10 is located closer to the insertion edge than the center of the water jacket spacer 10. Thus, when the insertion depth of the water jacket spacer 10 is greater than d1, the insertion load of the water jacket spacer 10 gradually increases. In contrast, the abutment portion 113a of the water jacket spacer 110 is located at a position further than the center of the water jacket spacer 110 in a direction opposite to the insertion direction. Thus, the insertion load of the water jacket spacer 110 is not generated until the insertion depth becomes greater than that in the case with the water jacket spacer 10. That is, the insertion load of the water jacket spacer 110 is not generated when the insertion depth is d1. The insertion load of the water jacket spacer 110 is generated when the insertion depth exceeds d2.

Furthermore, in the water jacket spacer 10, the abutment portion 13a of the leaf spring 13 abuts against the second wall 22b at the center of the water jacket spacer 10 in the insertion direction. In contrast, in the water jacket spacer 110, the abutment portion 113a of the leaf spring 113 abuts against the second wall 22b at a position further than the center of the water jacket spacer 110 in a direction opposite to the insertion direction.

When the abutment portion of the leaf spring abuts against the inner wall of the water jacket, the deformation amount of the leaf spring is maximized, and the leaf spring is flexed to the most. Furthermore, the urging force generated by the deformation of the leaf spring is also maximized. That is, in a state in which the water jacket spacer is inserted deeper after the abutment portion of the leaf spring abuts against the inner wall, the insertion load of the water jacket spacer is maximized.

Thus, in the case with the water jacket spacer 10, the insertion load caused by the urging force of the leaf spring 13 is maximized when half of the water jacket spacer 10 is inserted into the water jacket 22. In contrast, in the case with the water jacket spacer 110, the insertion load caused by the urging force of the leaf spring 113 is maximized when more than half the water jacket spacer 110 is inserted in the water jacket 22. That is, the water jacket spacer 110 has a reduced insertion load when the insertion depth is small. Thus, the work amount corresponding to an area A shown in FIG. 8 is reduced.

Furthermore, in the case with the water jacket spacer 10, the distal end portion 13b of the leaf spring 13 abuts against the holder 11. Thus, when the leaf spring 13 is deformed, friction occurs between the distal end portion 13b of the leaf spring 13 and the holder 11. In contrast, in the case with the water jacket spacer 110, only the proximal end of the leaf spring 113 is connected to the holder 11. That is, when the leaf spring 113 is deformed, no friction occurs between the distal end portion of the leaf spring 113 and the holder 11. Thus, the leaf spring 113 easily deforms when the water jacket spacer 110 is inserted. This structure prevents the insertion load of the water jacket spacer 110 from being increased and reduces the work amount corresponding to an area B shown in FIG. 4.

Furthermore, in the water jacket spacer 110, the abutment portion 113a of the leaf spring 113 is curved. Thus, compared with the water jacket spacer 10 of the first embodiment, in which the leaf spring 13 extends straight and bent at the abutment portion 13a, the deformation amount gradually increases until the deformation amount of the leaf spring 113 is maximized. That is, the urging force caused by the deformation of the leaf spring 113 is also gradually increased. Thus, the insertion load of the water jacket spacer 110 is also gradually increased. That is, in addition to the areas A, B shown in FIG. 8, the work amount corresponding to an area C is also reduced.

The second embodiment provides the following advantages in addition to the above-described advantages (1) to (7).

(8) The leaf spring 113 abuts against the second wall 22b of the water jacket 22 at a position further than the center of the water jacket spacer 110 in a direction opposite to the insertion direction. Thus, the insertion load caused by the urging force of the leaf spring is maximized when more than half the water jacket spacer 110 is inserted in the water jacket 22. This reduces the insertion load when the insertion depth of the water jacket spacer 110 is small.

(9) Since the abutment portion 113a of the leaf spring 113 is curved, the deformation amount is gradually increased until the deformation amount of the leaf spring 113 is maximized. That is, the urging force of the leaf spring 113 is also gradually increased in accordance with the deformation amount of the leaf spring 113. Thus, the insertion load is also gradually increased when the insertion depth of the water jacket spacer 110 is increased. This reduces the work amount in inserting the water jacket spacer 110.

Each of the above-described embodiments may be modified as follows.

The water jacket spacer may be applied to a cylinder block having a closed-deck structure. In the closed-deck cylinder block, the openings of the holes in the water jacket are not continuous, and the size of the holes is smaller than that in the open-deck cylinder block. In the closed-deck cylinder block also, the water jacket spacer can be inserted in the water jacket by adjusting the entire length of the water jacket spacer in accordance with the holes of the water jacket.

The water jacket spacers 10, 110 may be applied to a cylinder block having a V-type cylinder arrangement. Furthermore, the number of the cylinders of the internal combustion engine does not need to be four. Any open-deck cylinder block provides the same advantages as the above-described each embodiment by applying the water jacket spacer 10 or 110.

The number of the expansion members 12 secured to the holder 11 may be changed as required. The number of the expansion members 12 is preferably changed in accordance with the entire length of the water jacket spacer or the number of the cylinder bores of the cylinder block to which the water jacket spacer is applied. The number of the expansion members 12 may also be, for example, one.

Spaces are formed at both ends of the water jacket 22 with the water jacket spacers 10 or 110 inserted in the water jacket 22. However, the expansion members 12 may be arranged at both ends of the water jacket 22. This configuration provides the above-described advantages (1) to (6), or the above-described advantages (1) to (6), (8), and (9).

The expansion members 12 may be swelling members that expand by absorbing the coolant.

The holder 11, which configures the water jacket spacer, may be formed of plastic instead of metal.

1. A water jacket spacer that is applied to a cylinder block, which includes a water jacket that surrounds a plurality of cylinder bores, and is inserted in the water jacket, the water jacket spacer comprising:
an expansion member, which is arranged corresponding to each cylinder bore and expands in the water jacket;
a plate-shaped holder to which the expansion member is secured; and
an elastic member, which projects from the other side of the holder from the side on which the expansion member is provided and abuts against an inner wall of the water jacket, wherein
the holder curves to be shaped in conformance with the water jacket, and
the elastic member exerts an urging force to maintain the position of the holder in the water jacket.

2. The water jacket spacer according to claim 1,
wherein the cylinder block is an open-deck cylinder block,
the expansion member is one of a plurality of expansion members, and
the expansion members are secured to the holder.

3. The water jacket spacer according to claim 2,
wherein the water jacket is divided into two regions in a circumferential direction by an imaginary straight line that passes through all central axes of the cylinder bores, and
the holder couples all the expansion members arranged in one of the two regions.

4. The water jacket spacer according to claim 3,
wherein the water jacket spacer is one of a pair of water jacket spacers, and the pair of water jacket spacers is inserted in the water jacket.

5. The water jacket spacer according to claim 1,
wherein the elastic member projects at an angle from the holder,
the elastic member extends from an edge section of the water jacket spacer from which the water jacket spacer is inserted to gradually separate from the expansion member in a direction away from the edge section, and
the elastic member is a leaf spring that abuts against the inner wall of the water jacket.

6. The water jacket spacer according to claim 5,
wherein the leaf spring includes an abutment portion that abuts against the inner wall of the water jacket,
the abutment portion is formed by having part of the leaf spring to be curved, and
the abutment portion is located at a position further than a center in an insertion direction of the water jacket spacer in a direction opposite to the insertion direction.
